(19) United States
(12) Patent Application Publication
(10) Pub. No.: US 2008/0130674 A1
(43) Pub. Date: Jun. 5, 2008

(54) Method and System For Multi-User Channel Estimation in Ds-Cdma Systems

(76) Inventors: Messaoud Ahmed-Ouameur, Trois-Rivieres (CA); Daniel Massicotte, Trois-Rivieres (CA)

Correspondence Address: MUIRHEAD AND SATURNELLI, LLC, 200 FRIBERG PARKWAY, SUITE 1001, WESTBOROUGH, MA, 01581, US

(21) Appl. No.: 11/547,895

(22) PCT Filed: Apr. 8, 2005
(86) PCT No.: PCT/CA05/00543

§ 371 Date: Feb. 25, 2008

Related U.S. Application Data
(60) Provisional application No. 60/560,591, filed on Apr. 9, 2004.

(51) Int. Cl. H04B 7/216

(52) U.S. Cl. 370/441

(57) ABSTRACT

The method and system for multi-user channel estimation in a multi-access network comprises: providing a communication signal (rᵢ) providing an estimated communication signal Formula (I) generated using a spreading code signal (Cᵢ), an information sequence signal (Bᵢ) and a predicted composite channel impulse response signal Formula (II); comparing the communication signal (rᵢ) to the estimated communication signal Formula (I) to provide an error signal (εᵢ); and generating an estimated composite channel impulse response signal Formula (III) using the error signal (εᵢ), the spreading code signal (Cᵢ) and the information sequence signal (Bᵢ); the predicted composite channel impulse response signal Formula (II) providing the multi-user channel estimation. The proposed method, which is based on a LMS like algorithm, is an efficient and low complexity method allowing estimating and tracking even fast times varying multi-path channels. Instantaneously, the composite channel impulse response is computed and estimates of all possible path energies are computed to be used as an indicator of the significant paths (delays).

### FIELD OF THE INVENTION

The present invention relates to DS-CDMA (direct sequence-code division multiple access) systems. More specifically, the present invention is concerned with method and system for multi-user channel estimation in DS-CDMA systems.

### BACKGROUND OF THE INVENTION

Due to the inherent interference limitation of the code-division multiple access (CDMA) systems, some receivers utilize multiuser channel estimation approach, [1], [2], [3], [4], [5] and [6], to combat multiple access interference (MAI) along with the intersymbol interference (ISI). The above referenced algorithms are developed for CDMA systems with short spreading codes. However, spreading codes used in practical CDMA systems, e.g. WCDMA and cdma2000, have a period much larger than the symbol duration. Most of the existing algorithms are therefore either inapplicable or require prohibitive computational resources.

Some channel estimation algorithms have been suggested in [7], [8], [9], [10], [11], [12] for long code systems. The techniques in [9] and [10] use the interference cancellation and the minimum mean squared error (MMSE) approach, respectively, and assumes perfect knowledge of the spreading sequences, channel estimates and bits of the interfering users. In [8], an acquisition scheme for a single user entering the system is devised using the knowledge of the spreading sequence and delays of the interfering users, who have already been acquired, without using their bit decisions. Blind estimation on the complex channel amplitudes is studied in [11] and [12] assuming knowledge of the delays of the various propagation paths for the interferers and [10] develops channel estimation algorithms for synchronous downlink channels.

Designing efficient multiuser channel estimation and tracking for time varying multipath channels is a major concern. The current algorithms for channel estimation rely mainly on some type of averaging, assuming, of course, that the channel coefficients remain constant at least during the period of interest (training period, predefined window) and therefore lack the needed tracking capability. A maximum likelihood (ML) channel estimation [13] operates on an averaged decision statistic over successive (windowed) matched-filters' outputs for all users. With respect to implementation, Bhashyam and Aazhang in [13] designed an ML approach for long codes, applying gradient-based methods to approximate the ML solution and evenly distribute the computational burden over each sample, and thereby offering good tracking capabilities for slow channel variations. This method can be viewed as an iterative search for the composite channel impulse response of all users that minimizes a gradient with an “identity implementation law.”

Implementation complexity remains the driving factor for preferring one channel estimation algorithm over another, as long as performances are satisfactory. The correlator, because of the simple complexity it offers, is a good candidate. To improve the accuracy of the channel estimates provided by the correlator, the channel impulse response obtained is further processed by employing a low pass filter, called a channel estimation filter (CEF) (correlator-CEF). It is known that the Wiener filter is optimal as the CEF in a stationary channel in the minimum mean square error (MMSE) sense. To design a Wiener filter, however, it is essential to know the power spectrum of the channel and noise, which may not be obtainable in real time. Moreover, a large implementation complexity is required. The Doppler spectrum is usually spread to the maximum Doppler frequency of an experiencing channel. Thus it may be desirable to employ a brick-wall type lowpass filter such as the CEF, whose cut-off frequency is equal to the maximum Doppler frequency of the channel. Such a CEF may not be practical, however, owing to the difficulty of implementation using a small number of filter taps. As a result, the CEF is realized in the form of a conventional lowpass filter like the finite impulse response (FIR) filter, or infinite impulse response (IIR) filter. Such lowpass filters can provide relatively good channel estimation performance if they are appropriately designed according to the channel condition.

### SUMMARY OF THE INVENTION

According to the present invention, a multiuser-LMS-like structure along with smoothing and perdition filters to improve tracking quality applied to the received signal before despreading is provided. The choice for such an adaptation family stems from its low computational complexity and its regular structure, which is favourable for an efficient VLSI (Very Large Scale Integration) implementation where parallelism and wave pipelining, among other techniques, are easily applied. They are computationally effective due to the even distribution of the computation load over each symbol duration; no extra computation is required at the end of the processing window or preamble. Like Kalman-based channel estimation methods, an autoregressive stochastic model of correlated Rayleigh fading processes is used but indirectly embedded into the design. The attractive property of the proposed structure is the unique filter settings used for a large range of mobile speeds and for all users accessing the system. The design process is based on the following methodology: first, a p-order autoregressive stochastic model is designed for an average Doppler profile; second, the resulting model along with the admissible parameter-drift-to-noise floor ratio [39] are used to design the smoothing/prediction coefficients using Wiener LMS design methodology [39]; finally, a multiuser-LMS structure is augmented with an extra smoothing/prediction procedure.

The LMS structure takes into account all users' contributions simultaneously and delivers a composite channel impulse response, as in [13], at each symbol. The composite channel impulse response is defined to be at least an (N+1)K column vector, whose content provides the information about the multipath delays and time varying attenuations simultaneously. K represents the number of users and N the pilot (in case of cdma2000 and WCDMA) spreading factor.

A unique smoothing/prediction filter is designed based on a single p-order AR model over an averaged Doppler profile for all users. The adaptation step is dynamically examined at each iteration using the same approach as in steepest descent based methods.

As in [13], the multiuser-LMS structure are chosen so as to provide:
An even distribution of the computational burden over a training window or a preamble;
No extra heavy computation required at the end of a training window or a preamble; and
A regular structure for an efficient VLSI implementation.

More specifically, in accordance with a first aspect of the present invention, there is provided a method for multi-user channel estimation in a multi-access network comprising:

a) providing a communication signal (rᵢ) corresponding to instant i;

b) providing an estimated communication signal (\hat{r}ᵢ);

c) comparing the communication signal (εᵢ) to the estimated communication signal (\hat{r}ᵢ) to provide an error signal (εᵢ); and

d) generating an estimated composite channel impulse response signal (\hat{z}ᵢ) using the error signal.

The proposed method is an efficient and low complexity method allowing estimating and tracking even fast times varying multipath channels. Instantaneously, the composite channel impulse response is computed and estimates of all possible path energies (rather than the tap itself) are computed to be used as an indicator of the significant paths (delays). The proposed method makes use of a model allowing applying a LMS-like structure.

According to an illustrative embodiment of the method, the composite channel impulse response is sought as a solution to an optimization criteria based on minimizing the “tracking error” (rather than a gradient) using an LMS like implementation law endowed with a prediction/smoothing filter for tracking. Such algorithm uses prior information on the hypermodel the channel may assume and the designer may estimate. These priors information are imbedded in the prediction/smoothing filter.

The proposed method offers a considerable tracking performance at still low computational complexity close to LMS algorithm. More than that its computation load is evenly distributed over each bit (symbol).

It may be applied for long as well as for short codes, for any type of modulation, any type of training sequence, and may be easily applied to multi-rate systems using the concept of “virtual users”.

The proposed method can be used in a multi-stage method for channel estimation in a multi-access network to provide path attenuation {ŵ_{k,p}} or delay signal {\hat{τ}_{k,p}} for at least some of the users K; and where the method is repeated at least one time using selected components of the resulted estimated composite channel impulse response signal.

Unlike the method proposed in [29], which considered MIMO channels estimation model in a brief example, a channel estimation method according to the present invention allows to estimate the composite channel impulse response for all users simultaneously, rather than single user attenuation, by assuming perfect acquisition. This is done by processing the received signal before dispreading.

Also, a channel estimation method according to the present invention is less dependent on speed variations and does not assume any Doppler estimation, as it uses the average autocorrelation function over the entire range of Doppler frequency of interest.

According to a second aspect of the invention, there is provided an adaptive channel estimation processing module providing a plurality of estimated receiver's antennas composite channel impulse response signals for each communication channel signal of a transmitted communication signal in a multi-access network, comprising a processor receiving the transmitted communication channel signal and providing the plurality of estimated composite channel impulse response signals in accordance with control parameters being modified by an error feedback signal having a plurality of components, each of the plurality of components being related to the estimated received signal antennas and a feedback unit receiving the estimated composite channel impulse response and providing the plurality of estimated received signals for each channel antennas and providing the error feedback signal to the processor.

According to a third aspect of the present invention, there is provided an equalizer/detection unit for a multi-user access network system comprising:
a channel estimation module from the present invention; and

a data detection unit coupled to the channel estimation module to receive the plurality of estimated composite channel impulse response signals form the channel estimation module to use the plurality of estimated composite channel impulse response signals to provide estimated transmitted binary data.

According to a fourth aspect of the present invention, there is provided a multi-antenna system for a multi-access network comprising:

a plurality of receiving antennas, each having an antenna output;

a plurality of channel estimation modules from the present invention, each coupled to a respective of the plurality of receiving antennas so as to receive the transmitted communication channel signal from the antenna output; and

a finger management unit coupled to the plurality of channel estimation modules for receiving the plurality of estimated composite channel impulse response signals therefrom and for using the plurality of estimated composite channel impulse response signals to provide at least one of path attenuation and delay signal corresponding to each of the plurality of receiving antennas.

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

In the appended drawings:

FIG. 1 is a block diagram of a communication system incorporating an equalization/detection unit according to an illustrative embodiment of the present invention;

FIG. 2 is a block diagram illustrating the equalizer/detection unit from FIG. 1;

FIG. 3 is a flowchart illustrating a method for multi-user channel estimation in a multi-access system according to a first illustrative embodiment of the present invention;

FIG. 4 is a block diagram of the method from FIG. 3, illustrating the iterative nature of the method;

FIG. 5 is a block diagram detailing the composite channel impulse response prediction step illustrated in FIG. 4;

FIG. 6 is a block diagram detailing the smoothing and prediction finite impulse response substeps from the composite channel impulse response prediction step illustrated in FIG. 5;

FIG. 7 is a block diagram a method for multi-user channel estimation in a multi-access system according to a second illustrative embodiment of the present invention;

FIG. 8 is a block diagram of a multi-antenna receiving system for DS-CDMA systems according to an illustrative embodiment of the present invention;

FIG. 9 is a block diagram illustrating a multi-stage method for channel estimation in DS-CDMA systems using the channel estimation method from FIG. 3 according to a more specific illustrative embodiment of the present invention;

FIGS. 10A-10B are graphs illustrating the loss obtained through simulations using the method from FIG. 3, corresponding respectively to a mobile speed of 3 km/h and 50 km/h;

FIGS. 11A-11B are graphs illustrating the MMSE obtained through the simulations resulting in FIGS. 10A-10B, corresponding respectively to a mobile speed of 3 km/h and 50 km/h; and

FIGS. 12A-12B are graphs illustrating the Bit Error Rate (BER) obtained through the simulations resulting in FIGS. 10A-10B and 11A-11B, corresponding respectively to a mobile speed of 3 km/h and 50 km/h.

### DETAILED DESCRIPTION

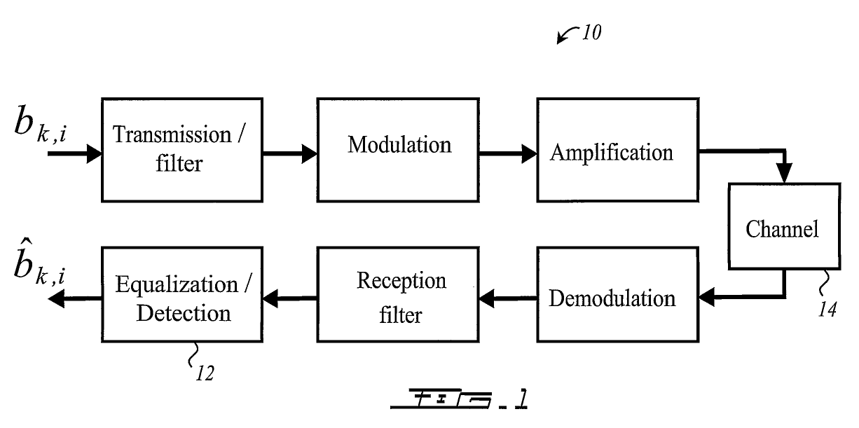

A communication system 10, incorporating an equalization/detection unit 12 according to an illustrative embodiment of the present invention, is illustrated in FIG. 1.

As illustrated in FIG. 1, the system 10 inputs the transmitted binary data bₖ and outputs the estimated transmitted binary data \hat{b}ₖ. Unlike in TDMA (Time Division Multiple Access) equalizers, DS-CDMA (Direct-Sequence Code Division Multiple Access) equalizers, such as unit 12, consist in removing intersymbol interference (ISI) from data received through a telecommunication channel 14 as well as Multiple Access Interference (MAI). Since DS-CDMA communication channels are believed to be well known in the art, and for concision purposes, only the equalization/detection unit 12 will be described herein in more detail.

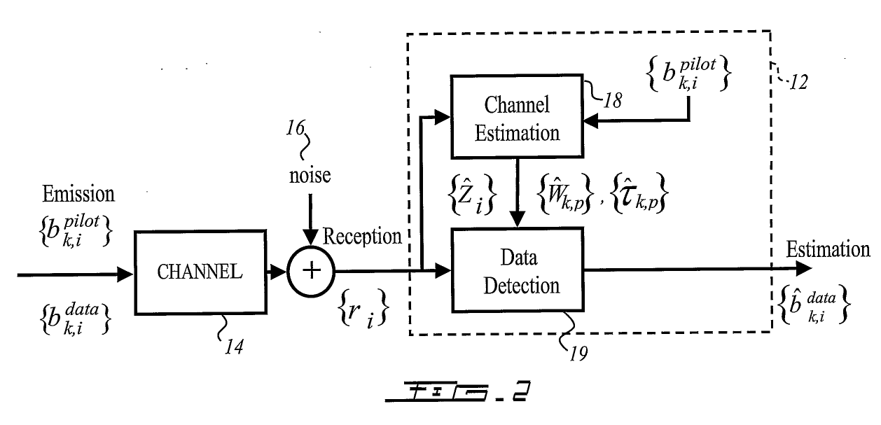

As illustrated in FIG. 2, the transmitted sequence defined by {b_{k,j}^{pilot}} and {b_{k,j}^{data}} correspond to pilot (control) sequence and data sequence respectively. These sequences, after channelization/spreading, past through channel 14 added by interference noise signal 16 to create the received signal {rᵢ} at the receiver. The role of equalizer 12 is to detect or estimate data bits transmitted for each user k from the received sequence {rᵢ}. The data detection module 19 uses the estimation of attenuation {ŵ_{k,p}} and delays {\hat{τ}_{k,p}} for each channel users k and path p to provide the estimated transmitted binary data \hat{b}ₖ.

Before describing the equalization/detection unit 12 in more detail a baseband model for DS-CDMA will first be presented.

In this model, a K user asynchronous direct sequence CDMA system with long spreading codes will be considered. The spreading sequence corresponding to b_{k,i}, the i^{th} bit of the k^{th} user, is denoted by c_{k,i}(t) and consists of N chips, where N is the spreading gain.

The corresponding discrete chip sequence is denoted by

[c_{k,i}[1]c_{k,i}[2] . . . c_{k,i}[N]].

The transmitted signal of the k^{th} user corresponding to an information sequence of length M is given in baseband format by

$${s}_{k} ( t ) = \sqrt{{E}_{k}} {\sum }_{i = 1}^{M} {b}_{k , i} {c}_{k , i} ( t - iT ) \qquad ( Equation 1 )$$

where T is the bit duration and Eₖ is the transmitted power of the user.

Let the channel be a multipath channel with Pₖ paths for the k^{th} user and let the complex attenuation and delay with respect to the timing reference at the receiver of the p^{th} path of the k^{th} user be denoted by w_{k,p} and τ_{k,p} respectively.

The received signal may be represented as

$$r ( t ) = {\sum }_{k = 1}^{K} {\sum }_{p = 1}^{{P}_{k}} {w}_{k , p} ( i ) {s}_{k} ( t - {τ}_{k , p} ) + n ( t ) \qquad ( Equation 2 )$$

where n(t) is the additive white Gaussian noise 16 (see FIG. 2).

As will become more apparent upon reading the following non restrictive description, a method for multi-user channel estimation method according to the present invention allows providing an estimate of the effective channel impulse response, which will be described hereinbelow in the discrete received signal model, therefore not requiring the information about the number of paths of each user.

The received signal is discretized at the receiver by sampling the output of a chip-matched filter at the chip rate [1], [4], [14]. The observation vectors are formed by collecting N successive outputs of the chip-matched filter r[n]. The observation vectors correspond to a time interval equal to one symbol period and start at an arbitrary timing reference at the receiver.

If it is assumed that all the paths of all users are within one symbol period, which is reasonably true for a pilot symbol worth of 256 chips as in WCDMA communication systems, from the arbitrary timing reference, only two symbols of each user in each observation window will be provided, and a representation as presented in [14] may be developed. It is believed to be within the reach of a person skilled in the art to extend the present model so that it include more general situations for the delays without affecting the derivation of the channel estimation algorithms [15].

The discrete received vector model of the received signal is given by

rᵢ=CᵢZᵢbᵢ+nᵢ (Equation 3)

where rᵢ is the i^{th} N×1 observation vector, Cᵢ is N×2K(N+1) spreading code matrix, Zᵢ is a 2K(N+1)×2K channel response matrix, bᵢ is a 2K×1 symbol vector and n, is a N×1 complex Gaussian zero-mean random vector with independent elements each of variance σ².

In particular, the spreading waveform matrix, Cᵢ, is constructed using the shifted versions of the spreading codes corresponding to the i^{th} and i+1^{th} symbols of each user in the observation window. Thus, Cᵢ is of the form

[C_{1,i}^{R}C_{1,i+1}^{L}C_{2,i}^{R}C_{2,i+1}^{L}, . . . C_{K,i}^{R}C_{K,i+1}^{L}] (Equation 4)

where

$${C}_{k , i}^{R} = [ \begin{matrix}{c}_{k , i} [ 1 ] & {c}_{k , i} [ 2 ] & ⋯ & {c}_{k , i} [ N ] & 0 \\ {c}_{k , i} [ 2 ] & {c}_{k , i} [ 3 ] & ⋯ & 0 & 0 \\ ⋮ & ⋮ & & ⋮ & ⋮ \\ {c}_{k , i} [ N - 1 ] & {c}_{k , i} [ N ] & ⋯ & 0 & 0 \\ {c}_{k , i} [ N ] & 0 & ⋯ & 0 & 0\end{matrix} ] \qquad ( Equation 5 )$$

is constructed with the right part of the spreading code of the k^{th} user corresponding to the i^{th} symbol and

$${C}_{k , i + 1}^{L} = [ \begin{matrix}0 & 0 & 0 & ⋯ & {c}_{k , i + 1} [ 1 ] \\ 0 & 0 & 0 & ⋯ & {c}_{k , i + 1} [ 2 ] \\ ⋮ & ⋮ & ⋮ & & ⋮ \\ 0 & 0 & {c}_{k , i + 1} [ 1 ] & ⋯ & {c}_{k , i + 1} [ N - 1 ] \\ 0 & {c}_{k , i + 1} [ 1 ] & {c}_{k , i + 1} [ 2 ] & ⋯ & {c}_{k , i + 1} [ N ]\end{matrix} ] \qquad ( Equation 6 )$$

is constructed with the left part of the spreading code of the k^{th} user corresponding to the i+1^{th} symbol.

Since the spreading codes change from symbol to symbol, the last columns of C_{k,i}^{R} and C_{k,i+1}^{L} are used additionally as compared to the short code case.

The channel response matrix Zᵢ is of the form diag(z_{1,i}, z_{1,i}, z_{2,i}, z_{2,i}, . . . , z_{K,i}, z_{K,i}) where z_{k,i} is the (N+1)×1 channel response vector for the k^{th} user in instant i. When rectangular chip waveforms of duration T_{c} are used, the q_{k,p}^{th}, and q_{k,p}+1^{th} element of z_{k,i} have a contribution of (1−γ_{k,p})w_{k,p}(i) and γ_{k,p}w_{k,p}(i) from the p^{th} path of the k^{th} user, where τ_{k,p}=(q_{k,p}+γ_{k,p})T_{c}. For example, when user k has only one path at delay τ_{k,1},

z_{k,i}=[0 . . . 0(1−γ_{k,1})w_{k,1}(i)γ_{k,1}w_{k,1}(i)0 . . . 0]^{T} (Equation 7)

where the non-zero elements are at the q_{k,1}^{th} and q_{k,1}+1^{th} positions. The symbol vector bᵢ=[b_{1,i}b_{1,j+1}, b_{2,i}b_{2,i+1}, . . . b_{K,i}b_{K,i+1}]^{T} has two symbols (chosen to be binary information bits ±1) for each user.

While Equation (3) is used to represent the received vector for detection, the received vector for channel estimation is rewritten as

rᵢ=CᵢBᵢzᵢ+nᵢ (Equation 8)

where

zᵢ=[z₁^{T}z₂^{T} . . . z_{K}^{T}]^{T} (Equation 9)

is a K(N+1)×1 channel response vector and Bᵢ is a 2K(N+1)×K(N+1) matrix defined as

$${B}_{i} = [ \begin{matrix}{b}_{1 , i} & 0 & 0 & ⋯ & 0 & 0 \\ {b}_{1 , i + 1} & 0 & 0 & ⋯ & 0 & 0 \\ 0 & {b}_{2 , i} & 0 & ⋯ & 0 & 0 \\ 0 & {b}_{2 , i + 1} & 0 & ⋯ & 0 & 0 \\ ⋮ & ⋮ & & & & ⋮ \\ ⋮ & ⋮ & & & & ⋮ \\ 0 & 0 & 0 & ⋯ & 0 & {b}_{K , i} \\ 0 & 0 & 0 & ⋯ & 0 & {b}_{K , i + 1}\end{matrix} ] ⊗ {I}_{N + 1} \qquad ( Equation 10 )$$

where \textcircled{x} denotes the Kronecker product and I_{N+1} is the identity matrix of rank N+1.

Thus N+1 channel parameters are estimated for each user.

It is reminded that this effective channel response accounts for all the paths under the assumption that their delays are within one symbol duration. This assumption is realistic for WCDMA and CDMA2000 systems where the pilot bits are spread over 256 and 128 (384) chips respectively. These pilot bits durations are enough to encompass all possible path delays in the mobile wireless channels such as vehicular A/B and pedestrian A/B.

The number of non-zero coefficients in this effective channel response vector is determined by the number of paths and delays as in Equation 7.

It was first mentioned in [16] that the estimation of channel coefficients is equivalent to carrier phase tracking, and more work, such as in [17] and [18], was devoted to applying the Kalman filter to channel estimation. In most of these studies the fading channel was modeled as an autoregressive (AR) process in order to apply the Kalman filter. It has been shown that a second order AR process (AR2) may approximate the Jakes model [19] and may be used as a hyper model embedded into Kalman filter. It was observed in [20] that the spectral peak frequency of AR2 process should be adjusted by a factor of \sqrt{2} from the maximum Doppler frequency.

In [19], Jakes proposed to model a Rayleigh fading process w(t) by a number of oscillators with different phases and frequencies which reflect the Doppler spread. Jakes model was further modified in [21] to satisfy the desired properties of a fading channel, i.e., the in-phase and quadrature components are uncorrelated and their variance are identical. The modified model of the Rayleigh fading process is [21]

$$w ( t ) = \sqrt{\frac{2}{{N}_{d}}} {\sum }_{n = 1}^{{N}_{d}} {e}^{j {φ}_{n}} cos ( 2 π {f}_{d} t cos ( {α}_{n} ) ) \qquad ( Equation 11 )$$

where N_{d} is the number of distinct oscillators (the total number of oscillators is 4N_{d}), φₙ the phase of the n^{th} oscillator and

$${α}_{n} = 2 π \frac{n - 0.5}{4 {N}_{d}} .$$

If the fading coefficients modeled by an AR2 process are considered, it is possible to write

w(i)=−a₁w(i−1)−a₂w(i−2)+e(i) (Equation 12)

where e(i), the driving noise of the fading process, is a complex zero-mean white Gaussian process. The AR2 process parameters a₁ and a₂ are determined by the location of the poles of the transfer function on the unite circle. These parameters are closely related to the physical parameters of the underlying fading process by

a₁=−2r_{d} cos(2πf_{d}′T) (Equation 13)

a₂=r_{d}² (Equation 14)

where f_{d}′ is the spectral peak frequency, T is the symbol period, and r_{d} is the pole radius which corresponds to the steepness of the peaks of the power spectrum. It has been shown in [22] that

$${f}_{d}^{′} = \frac{{f}_{d}}{\sqrt{2}}$$

where f_{d} is the maximum Doppler frequency.

The above-described AR2 model was motivated by the fact that the design based on Kalman filtering would not be complex insofar as a higher order is not used. Unfortunately, the AR2 model is far from being a good approximation as it has been demonstrated by Baddour and Beaulieu [28], who show that an AR model order of at least 100 is sometimes required. The methodology proposed in [28] is used herein to compute the AR coefficients. However, unlike in [28] an averaged autocorrelation sequence over the Doppler range of interest is used to solve

R_{ww}a=−r_{ww} (Equation 15)

where

$${R}_{ww} = [ \begin{matrix}{r}_{ww} [ 0 ] & {r}_{ww} [ - 1 ] & ⋯ & {r}_{ww} [ - p + 1 ] \\ {r}_{ww} [ 1 ] & {r}_{ww} [ 0 ] & ⋯ & {r}_{ww} [ - p + 2 ] \\ ⋮ & ⋮ & ⋰ & \\ {r}_{ww} [ p - 1 ] & {r}_{ww} [ p - 2 ] & ⋯ & {r}_{ww} [ 0 ]\end{matrix} ] ,$$

r_{ww}=[r_{ww}[1]r_{ww}[2] . . . r_{ww}[p]]^{T} and a=[a₁a₂ . . . aₚ]^{T}

The averaged autocorrelation sequence r_{ww}[n] is suggested for the absolute time lag n, to be given by

$${r}_{ww} [ n ] = {\sum }_{s = 1}^{S} {J}_{0} ( 2 π {f}_{m}^{s} \vert n \vert ) Pr ( {f}_{m}^{s} ) \qquad ( Equation 16 )$$

where J₀ (•) is the zero^{th}-order Bessel function of the first kind and Pr(fₘ^{s}) is the probability density function, intuitively chosen, for the normalized maximum Doppler frequency (fₘ^{s}=f_{d}^{s}T=vₛf_{c}T/c) corresponding to the mobile speed vₛ in meter per second. The weighting profile Pr(fₘ^{s}) may take a range of profiles ranging from a simple uniform distribution to a bell shaped profile over the desired speed range delimited by vₛ₌₁ and v_{s=S}. The numerical problem encountered in solving (15) is addressed in [28], so that a heuristic solution exists for a given order p.

Now that the ARp is designed, a=[a₁a₂ . . . aₚ]^{T} can be used to design the filter coefficient using the procedure developed in [29].

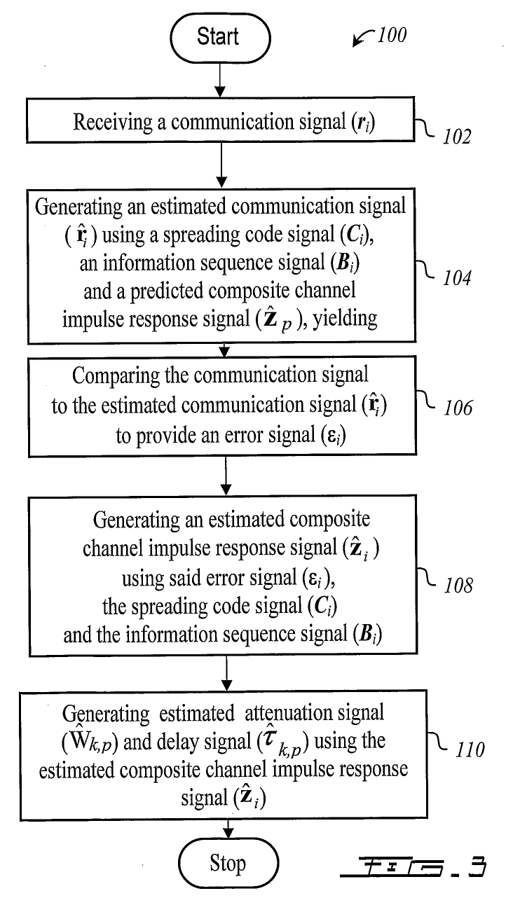

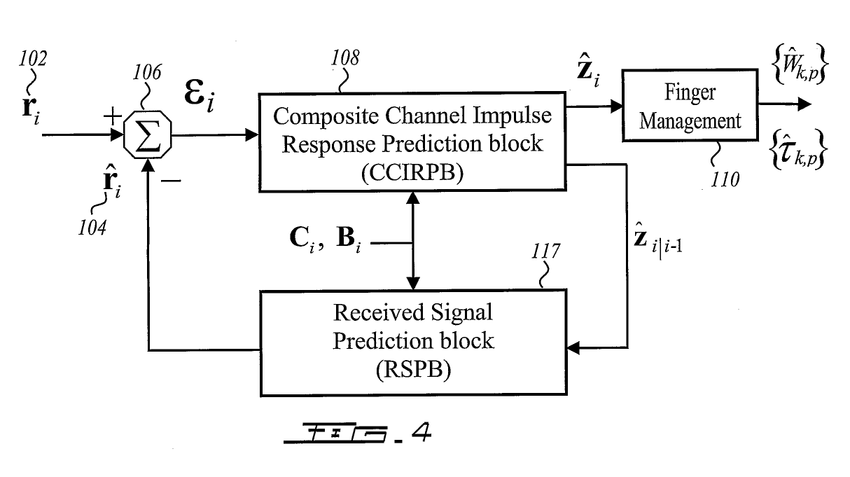

Using the signal model from Equation (8) highlighting the composite impulse response for all users, a method 100 for multi-user channel estimation in DS-CDMA systems according to a first illustrative embodiment of the present invention will now be described with reference to FIGS. 3 and 4.

As illustrated in FIG. 3, the method 100 comprises the following steps:
102—receiving a communication signal (rᵢ);
104—generating an estimated communication signal (\hat{r}ᵢ) using a spreading code signal (Cᵢ), an information sequence signal (Bᵢ) and a predicted composite channel impulse response signal (\hat{z}_{i|i-1}), yielding \hat{r}ᵢ=CᵢBᵢ\hat{z}_{i|i-1} (Equation 17);
106—comparing the communication signal (rᵢ) to the estimated communication signal (\hat{r}ᵢ) to provide an error signal εᵢ=rᵢ−\hat{r}ᵢ (Equation 18);
108—generating an estimated and predicted composite channel impulse response signal (\hat{z}ᵢ and \hat{z}_{i|i-1}) using the error signal (εᵢ), the spreading code signal (Cᵢ) and the information sequence signal (Bᵢ); and
110—generating estimated attenuation signal {ŵ_{k,p}} and delay signal {\hat{τ}_{k,p}} using the estimated composite channel impulse response signal.

Each of these steps will now be described in more detail.

Steps 102 to 108 is an iterative process for i=1, 2, . . . , M where M is defined by Equation 1 (for example, M=150 for a time frame in WCDMA) This iterative process is illustrated in FIG. 4.

In step 102, a communication N×1 vector signal (rᵢ) is received at a base station or at a mobile station (both not shown). It is reminded that the received signal (rᵢ) at the base station is a superposition of the attenuated and delayed signals transmitted by all K users (see Equation 2).

In step 104, an estimated communication signal (\hat{r}ᵢ) is generated using a spreading code signal (Cᵢ), an information sequence signal (Bᵢ) and a predicted composite channel impulse response signal (\hat{z}_{i|i-1}).

More specifically:

\hat{r}ᵢ=CᵢBᵢ\hat{z}_{i|i-1} with \hat{z}_{0|0-1}=0 (Equation 17)

Since the method 100 is an iterative process, it will be shown here in below how the predicted composite channel impulse response signal (\hat{z}_{i|i-1}) is computed in step 108.

The communication signal (rᵢ) is then compared to the estimated communication signal (\hat{r}ᵢ) to provide an error signal (step 106). More specifically, a simple subtraction is used:

εᵢ=rᵢ−\hat{r}ᵢ (Equation 18).

Equation 18 can also be expressed as:

εᵢ=rᵢ−Xᵢ^{H}\hat{z}_{i|i-1}

where X^{H}=CᵢBᵢ and dim(X^{H})=N×(N+1)K.

Step 108, an estimated composite channel impulse response signal (\hat{z}ᵢ) 109 is generated using the error signal (εᵢ), the spreading code signal (Cᵢ) and the information sequence signal (Bᵢ).

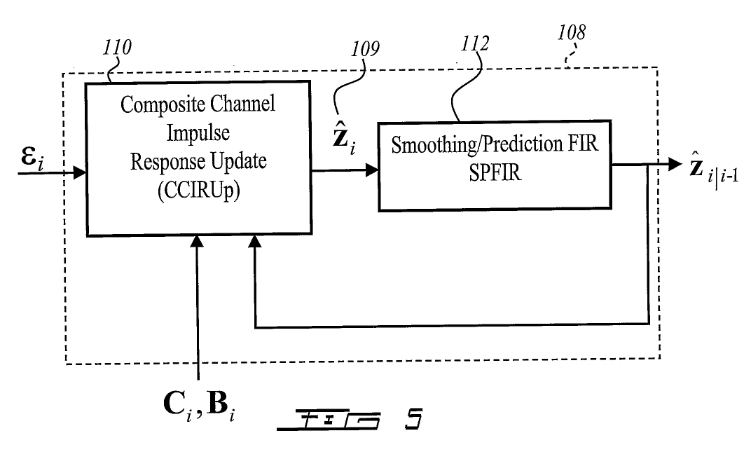

More specifically, as illustrated in FIG. 5, the estimated composite channel impulse response signal (\hat{z}ᵢ) 109 is generated in what can be seen as a substep 110 of step 108, where \hat{z}ᵢ is computed as follows:

\hat{z}ᵢ=\hat{z}_{i|i-1}+μR⁻¹Xᵢεᵢ (Equation 19)

where R=E{Xᵢ^{H}Xᵢ} or simply R=I for some cases and the parameter μ will be described furtherin.

It is to be noted that \hat{z}_{i|i-1} is the prediction of \hat{z} at instant i tanking into account all data until instant i−1 and \hat{z}_{i+1|i} is the prediction of \hat{z} at instant i+1 tanking into account all data until instant i.

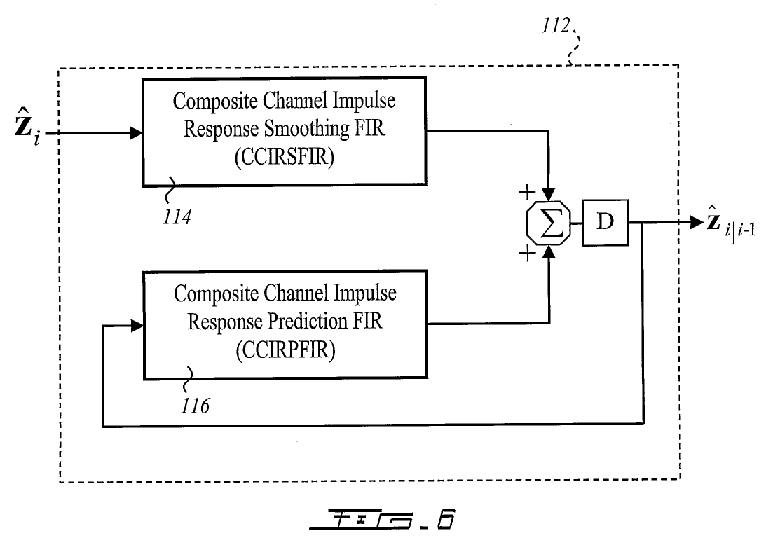

Step 108 further includes the substeps 112, where the one step prediction \hat{z}_{i+1|i} is computed as (see FIG. 6)

\hat{z}_{i+1|i}=\hat{z}ᵢ^{predition}+\hat{z}ᵢ^{smoothing} (Equation 20);

where the smoothing FIR (Finite Impulse Response) (substep 114) is given by

$${\hat{z}}_{i}^{smoothing} = - {\sum }_{n = 1}^{{N}_{smoothing}} {ξ}_{n} {\hat{z}}_{i - n - 1} \qquad ( Equation 21 )$$

and the prediction FIR (substep 116) is given by

$${\hat{z}}_{i}^{prediction} = - {\sum }_{n = 1}^{{N}_{prediction}} {ζ}_{n} {\hat{z}}_{i - n + 1 \vert i - n} . \qquad ( Equation 22 )$$

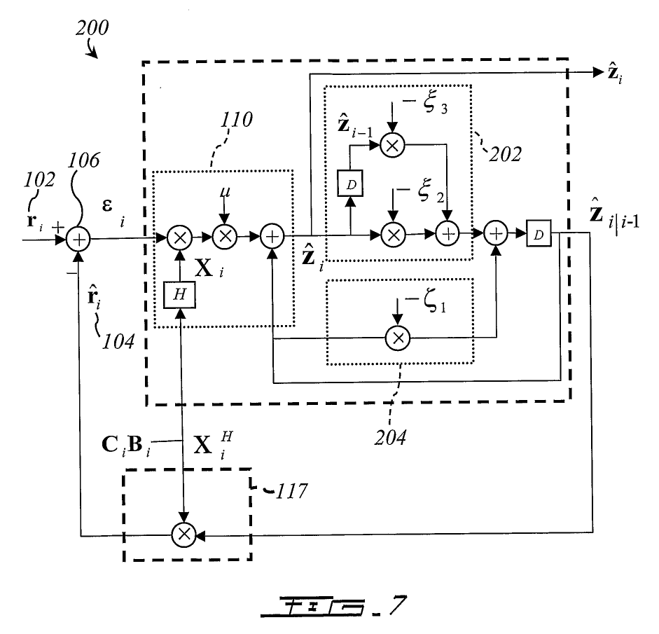

Turning now to FIG. 7, a method 200 for multi-user channel estimation in multi-access systems according to a second illustrative embodiment of the present invention will now be described. Since the method 200 is very similar to the method 100, and for concision purposes, only the differences between the two methods will be described herein. The method 200 is based on the AR2 model described hereinabove.

As can be seen from FIG. 7, only steps 202-204 differ respectively from steps 114 and 116:

### Step 202:

\hat{z}ᵢ^{smooting}=−ξ₁\hat{z}ᵢ−ξ₂\hat{z}ᵢ₋₁ (Equation 23)

and step 204:

\hat{z}ᵢ^{prediction}=−ζ₁\hat{z}_{i|i-1} (Equation 24)

where

$${ζ}_{1} = ( 1 - μ ) {ξ}_{1} {ξ}_{2} , {ξ}_{1} = \frac{{a}_{1}}{1 + {a}_{2} ( 1 - μ )} and {ξ}_{2} = {a}_{2} ,$$

with a₁ and a₂ provided respectively by Equations 13 and 14.

It is to be noted that, in a standard LMS structure, Equation 20 is implemented using an identity law \hat{z}_{i+1|i}=\hat{z}ᵢ. Using the procedure outlined in [29] after a proper choice of the AR model order p and the step size μ, the coefficients ξₙ and ζₙ are computed. The AR order is driven by complexity constraints: the larger the order is, the more accurate the AR model is at the expense of a complex design. μ can be chosen, for example, by applying the steepest descent technique.

Step 110 is a finger management step, which includes extracting the delays and path attenuation values for each users from the vector \hat{z}ᵢ.

When the estimated composite channel impulse response signal (\hat{z}ᵢ) is available, it can be used to compute the K(N+1)×1 vector variance, which can be expressed as:

$${v}_{i} = \frac{i - 1}{i} {v}_{i - 1} + \frac{1}{i} {w}_{i} \qquad ( Equation 25 )$$

with

wᵢ=[|\hat{z}_{i,1}|²,|\hat{z}_{i,2}|², . . . , |\hat{z}_{i,K(N+1)}|²]^{T} (Equation 26)

for i=1, 2, . . . , M with v₀=0 and z_{i,j} presents the jth elements of the vector z at instant i.

For delay detection, the variance vector v_{M} is searched over by segments, for each user k, beginning at position (k−1)(N+1)+1 and terminating at position k(N+1) to select the largest components (p=1, 2, . . . , Pₖ) to be considered as the correct (most significant) path position (delay) for which the path attenuation, {ŵ_{k,p}}, is deduced from \hat{z}ᵢ at the same element position ({\hat{τ}_{k,p}}).

Returning to step 108 and to Equation 19, for example, methods to determine the value of μ will now be described.

One way to search dynamically for μ is to compute μ at each iteration i=1, 2, . . . , M, as

$${μ}_{i} = \frac{{ɛ}_{i}^{H} {ɛ}_{i}}{{ɛ}_{i}^{H} {X}_{i}^{H} {X}_{i} {ɛ}_{i}} or {μ}_{i} = \frac{{ɛ}_{i}^{H} {ɛ}_{i}}{2 N φ} \qquad ( Equation 27 )$$

where φ is a constant integer that can be set to ensure that μᵢ<1.

The above formula can be replaced, in some contexts by

$${μ}_{i} = 1 - \frac{{δ}_{u}}{\vert {ɛ}_{i} \vert} , {δ}_{u} ∈ [ 0 ∞ ) or {μ}_{i} = \frac{{‖ {X}_{i} {ɛ}_{i} ‖}^{2}}{{‖ {X}_{i}^{H} {X}_{i} {ɛ}_{i} ‖}^{2}} \qquad ( Equation 28 )$$

The Multi-user Steepest Wiener LMS (Multi-user S-WLMS) can also be used for setting shows stable and suitable solution for setting μ, however at an additional computational cost compare to using Equation 27.

The design of prediction/smoothing filter coefficients for a general ARn channel model (corresponding to step 112 on FIG. 5) can be achieved via computer search so that the MMSE (Minimum Mean Square Error) on the composite channel estimates is minimized or minimize the BER (Bit error Rate) at the output or a detector.

Alternatively, the following time-saving methodology can be devised offline:
a) p is set at a given desired value, such as 6;
b) μ is varied along a range of discrete values sweeping the continuous range, for example [0.001 0.5];
c) as Equation (15) is solved, the filters' smoothing/prediction coefficients are deduced using a Wiener LMS method;
d) finally, the entire design is used along with a detector. The BER performance allows dictating the appropriate range of μ. This value can be used to make the appropriate final design settings. The process is iterated a few times to determine approximately the desired range of μ. This has shown appropriate results in simulation in both cdma2000 and WCDMA environments.

Since the Wiener LMS method is believed to be well known in the art, it will not be described herein in more detail.

The equalization/detection unit 12 introduced in reference to FIG. 2, and more specifically the channel estimation module 18 will now be described in more detail.

The adaptive channel estimation processing module 18, providing a plurality of estimated receiver's antennas composite channel impulse response signals for each communication channel signal of a transmitted communication signal in a multi-access network, comprises a processor receiving the transmitted communication channel signal 102 and providing the plurality of estimated composite channel impulse response signals 109 in accordance with control parameters being modified by an error feedback signal having a plurality of components, each of the plurality of components (not shown) being related to the estimated received signal antennas (not shown) and a feedback unit (not shown) receiving the estimated composite channel impulse response and providing the plurality of estimated received signals for each channel antennas and providing the error feedback signal to the processor.

Of course, the channel estimation module 18 may take many forms accordingly to systems with one transmitting antenna-one receiving antenna to systems with muti-transmitting-multi-receiving antennas as will now be described in more detail.

Multi-Antennas and Oversampling

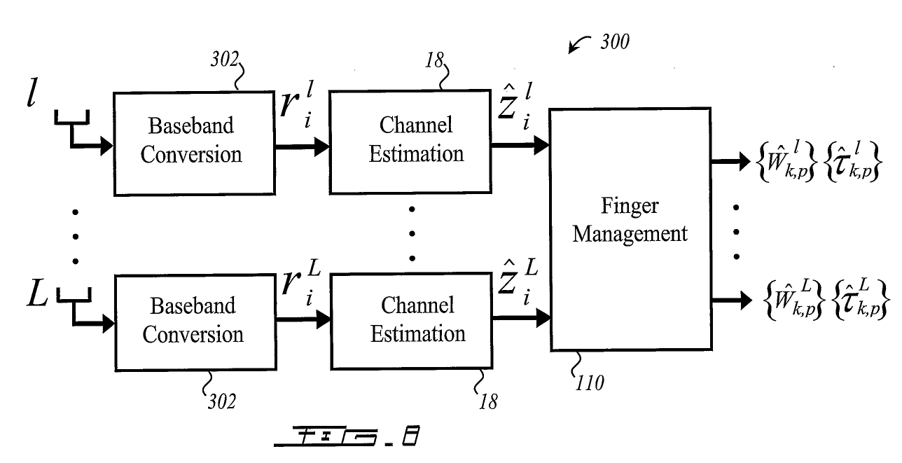

A multi-antenna system 300 for DS-CDMA systems according to an illustrative embodiment of the present invention will now be described with reference to FIG. 8. The multi-antenna system 300 comprises a plurality of receiving antennas I to L, which output is processed by a separate channel estimation module 18 as described hereinabove after baseband conversion through respective baseband conversion units 302. All the units 18 will be sharing the same information, namely Xᵢ. The output of each channel estimation module 18 is feed to a finger management unit 110.

In case of multiple transmitting antennas (Q transmitting antennas), the channel estimation module 18 sees a new Xᵢ which is, relatively to one-transmitting antenna case, augmented by a factor of Q to account for the spreading codes of all transmitting antennas. This can be view as replacing K by QK in the over all dimensions, which can be seen as every transmitting antenna represent a single user, hence facing a system with QK users. The transmitting antennas are, of course, endowed with different spreading codes.

The method does include over-sampling case where rᵢ is of dimension NOs, where Os is the over sampling rate.

### Multi-Stage Channel Estimation Module

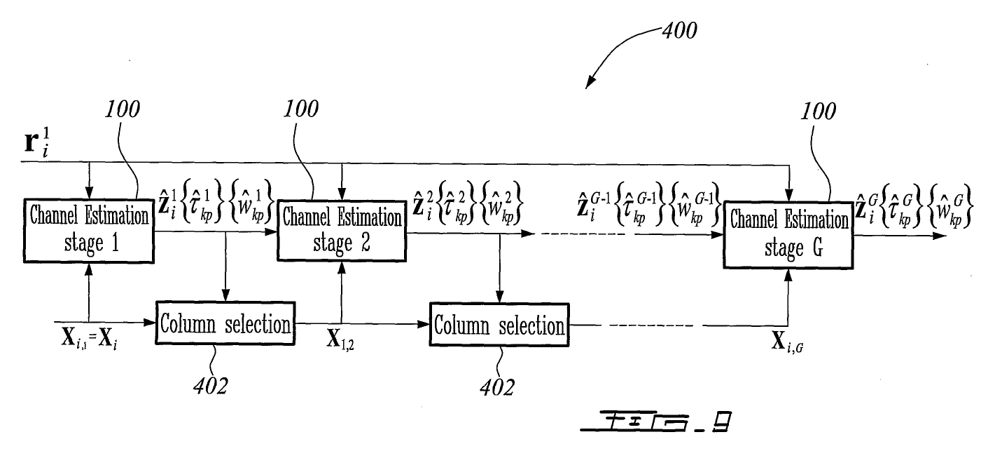

As depicted in FIG. 9, a multi-stage method 400 for channel estimation in DS-CDMA systems using the channel estimation method 100 according to a more specific illustrative embodiment of the present invention. The first stage is provided by the above described channel estimation method 100 without a priori knowledge about the delays (paths positions), so the only known information is the received signal rᵢ and the pilot spread information (Xᵢ). A rough estimate is available at output of the first stage for each time instant i. The available \hat{z}ᵢ¹, ŵ_{k,p}¹ and \hat{τ}_{k,p}¹ are feed to the second channel estimation stage. The second stage admits at its input the received signal rᵢ or an oversampled version of rᵢ, the column-reduced version of X_{i,1}(X_{i,1}=Xᵢ), namely X_{i,2}. X_{i,2} is an N×K(L2+1) matrix where L2 is less than N, i.e. X_{i,2} has less columns that X_{i,1}. The columns are selected according to suggested delays from the previous stage. The block 402, suggests for each user k, L2 columns around the suggested delays from the previous stage, Here L2 is greater than P, the number of possible paths, but less than N. The process is carried over certain number G of stages. The last stage G delivers the final channel estimates, namely the paths' delays and attenuations that can be used by a detector/equalizer. The last stage sees rᵢ, and X_{i,G} with very reduced number of columns as its inputs.

The multi-stage configuration can be implemented in three modes:

Mode 1: at this operational mode, stage G starts processing instantaneously at each iteration i. So that at each iteration all stages are functional.
Mode 2: stage g starts processing after a certain number of pilots, for example M, or slots/frames as needed. So that one stage is function for M pilots (slots/frames), the next stage will follow and so on.
The second mode incurs some delay but offers reliable inputs to each stage. While mode 1, offer some pipelining aspects, reducing the processing delay, but inputs are not that reliable as in mode 2.
Mode 3: it works in one of the modes stated above (mode 1 or 2), with an exception of using a Correlator at the first stage where the Correlator suggests more than P delays let say L1 where L1 is less than N but a lot bigger than P. (P for some reference takes values between 4 and 6 in WCDMA and cdma2000 systems)

### Simulation Results

Before describing simulation results, channel estimation methods from the prior art will first be briefly described, since the simulation results will be compared to data obtained using such methods from the prior art.

### Maximum Likelihood Channel Estimation

The maximum likelihood (ML) estimate of the channel response of all the users [13] will now be presented (z considering a time invariant channel) using the knowledge of their spreading codes and transmitted bits. These known bits could be available either as a preamble before the data or as pilot bits in a separate pilot channel.

In the estimation phase, training or pilot sequences are assumed to be used and in the tracking phase, data decisions from the detector can be fed back to the estimator. The joint conditional distribution of M received observation vectors (r₁, r₂, r_{M}), given the knowledge of the spreading sequences, channel and the bits is given by

$$p ( {r}_{1} , {r}_{2} , … , {r}_{M} / {C}_{1} , {C}_{2} , … , {C}_{M} , {B}_{1} , {B}_{2} , … , {B}_{M} , z ) = \frac{1}{{( π {σ}^{2} )}^{NM}} exp \{ \frac{1}{{σ}^{2}} {\sum }_{i = 1}^{M} {( {r}_{i} - {C}_{i} {B}_{i} z )}^{H} ( {r}_{i} - {C}_{i} {B}_{i} z ) \} \qquad ( Equation 28 )$$

the estimate \hat{z}_{ML}(M) that uniquely maximizes this likelihood function is the ML estimate and it satisfies Equation 29

$$\{ {\sum }_{i = 1}^{M} {( {C}_{i} {B}_{i} )}^{H} ( {C}_{i} {B}_{i} ) \} {\hat{z}}_{ML} ( M ) = {\sum }_{i = 1}^{M} {( {C}_{i} {B}_{i} )}^{H} {r}_{i} \qquad ( Equation 29 )$$

For simplicity,

$$\frac{1}{M} {\sum }_{i = 1}^{M} {( {C}_{i} {B}_{i} )}^{H} ( {C}_{i} {B}_{i} )$$

is denoted by R_{M}, a (N+1)K(N+1)K matrix and

$$\frac{1}{M} {\sum }_{i = 1}^{M} {( {C}_{i} {B}_{i} )}^{H} {r}_{i}$$

by y_{M}, a (N+1)K×1.

The rank of R_{M} increases by N with each additional term (CᵢBᵢ)^{H}(CᵢBᵢ) in the summation. This is based on the assumption that random spreading codes are used and the spreading codes over this duration are linearly independent.

Therefore, for R_{M} to be full rank, M should be at least equal to K+[K/N]. The current and next generation standards provide enough preamble or pilot resources to easily satisfy this condition. Therefore, assuming that R_{M} is full rank,

\hat{z}_{ML}(M)=R_{M}⁻¹y_{M} (Equation 30).

Since rᵢ is jointly Gaussian random vector with mean CᵢBᵢz and covariance matrix σ²I, any linear transformation Trᵢ of rᵢ is also jointly Gaussian random vector with mean TᵢBᵢz and covariance matrix σ²TT^{H}. Using this property of Gaussian random vectors, it may be shown that \hat{z}_{ML}(M) is also jointly Gaussian with mean z and covariance matrix σ²R_{M}⁻¹/M [13].

For comparison purposes the single user (correlator) channel estimate given by

$${\hat{z}}_{SU} = \frac{1}{NM} {\sum }_{i = 1}^{M} {( {C}_{i} {B}_{i} )}^{H} {r}_{i} \qquad ( Equation 31 )$$

### Iterative Channel Estimation

The maximum likelihood estimate obtained in the previous section will now be approximated using iterative algorithms developed using gradient-based adaptation [13]. Iterative algorithms based on the true gradient or an estimated stochastic gradient have been used earlier for various adaptive filtering and detection problems [23], [24]. In reference [13] gradient-based adaptation techniques have been applied using the exact gradient in our problem of multi-user channel estimation.

A direct computation of the exact ML channel estimate involves the computation of the correlation matrix R_{M} and then the computation of R⁻¹_{M}yₘ at the end of the preamble. However, the direct computation of the inverse of the correlation matrix at the end of the preamble is computationally intense and could delay the channel estimation process beyond the preamble duration and limit the information rate.

### Gradient Descent Method

The simplest gradient descent algorithm performs the following computations during the i^{th} bit duration.

1. Computing

$${R}_{i} = \frac{i - 1}{i} {R}_{i - 1} + \frac{1}{i} {( {C}_{i} {B}_{i} )}^{H} ( {C}_{i} {B}_{i} ) \qquad ( Equation 32 )$$

2. Computing

$${y}_{i} = \frac{i - 1}{i} {y}_{i - 1} + \frac{1}{i} {( {C}_{i} {B}_{i} )}^{H} {r}_{i} \qquad ( Equation 33 )$$

3. Updating the Estimate \hat{z} Via

\hat{z}⁽ⁱ⁾=\hat{z}⁽ⁱ⁻¹⁾−μ(Rᵢ\hat{z}⁽ⁱ⁻¹⁾−yᵢ) (Equation 34)

where Rᵢ\hat{z}⁽ⁱ⁻¹⁾−yᵢ is the gradient of the squared error surface (corresponding to the exponent in the likelihood function that needs to be minimized) and μ should be chosen to ensure convergence and to control speed of convergence. In each iteration, the estimate of the channel is updated by taking a step along the gradient vector.

According to this algorithm, the ML estimate for a preamble of length i is approximated as soon as the i^{t} bit is received. In fact, the updating step (step 3) may be repeated to improve accuracy. It may be repeated as many times as allowed by the available computational resources. It will be assumed that this updating is done only once per bit. Therefore, the number of iterations is equal to the preamble length.

### Steepest Descent Method

In the simple gradient descent algorithm for channel estimation, the step size is chosen to be constant for all the iterations. To speed up convergence, the step size may be chosen optimally for each iteration to minimize the squared error achieved by the updating step (step 3 which updates the channel estimate along the direction opposite to the gradient). Using at each iteration i the step size suggested in [13]

$${μ}_{i} = \frac{{ɛ}_{i}^{H} {ɛ}_{i}}{{ɛ}_{i}^{H} {R}_{i} {ɛ}_{i}} \qquad ( Equation 35 )$$

The above formula can be replaced, in some contexts by

$${μ}_{i} = 1 - \frac{{δ}_{u}}{\vert {ɛ}_{i} \vert} , {δ}_{u} ∈ [ 0 ∞ ) \qquad ( Equation 36 )$$

The optimal step size can be calculated using the knowledge of Rᵢ and the gradient. Therefore, the steepest descent algorithm may be implemented with the same information needed for the constant step size algorithm. Further speed up in convergence may be achieved by choosing the search directions in addition to choosing the step size for each iteration. This may be done by the conjugate gradient algorithm [25].

In the conjugate gradient algorithm, the search direction in any iteration is chosen to be orthogonal to the search directions used in the previous iterations. The steepest descent algorithm does not ensure this since it uses the gradient directly as the search direction. However, the implementation of the conjugate gradient algorithm would require significant additional computation to obtain the search directions.

### Tracking Time-Varying Channels

The iterative channel estimation algorithm scheme may be easily extended to track time variations in the channel after the preamble. The channel is assumed to be approximately constant over the preamble duration and the tracking is performed by sliding the estimation window and using data decisions instead of training sequences. At this stage, the past channel estimates are used to detect the data in the payload which will be used in turn for channel estimation, till the next preamble.

In the tracking scheme, the correlation matrix R_{M} and the matched filter outputs y_{M} are averaged over a sliding window of length M. The tracking is done as follows:
1. Detecting bits using multi-shot multistage detection with previous channel estimate;
2. Computing new correlation matrix and matched filter vector: if R_{M}^{old} corresponds to the old window over the time indices T+1, T+2, . . . , T+M and D bits for user are detected using multistage detection, then

$$\begin{matrix}{R}_{M}^{new} = {R}_{M}^{old} + {\sum }_{i = T + M + 1}^{T + M + D} {( {C}_{i} {B}_{i} )}^{H} ( {C}_{i} {B}_{i} ) - {\sum }_{i = T + 1}^{T + D} {( {C}_{i} {B}_{i} )}^{H} ( {C}_{i} {B}_{i} ) & ( Equation 37 ) \\ {y}_{M}^{new} = {y}_{M}^{old} + {\sum }_{i = T + M + 1}^{T + M + D} {( {C}_{i} {B}_{i} )}^{H} {r}_{i} - {\sum }_{i = T + 1}^{T + D} {( {C}_{i} {B}_{i} )}^{H} {r}_{i} & ( Equation 38 )\end{matrix}$$

3. Updating channel estimate

\hat{z}^{new}=\hat{z}^{old}−μ(Rᵢ^{new}\hat{z}^{old}−yᵢ^{new}) (Equation 39)

As discussed for the estimation scheme, the updating step may be repeated to improve estimation accuracy. Since the channel is assumed to be roughly constant over the window length, the ML channel estimate for the new window should be very close to the previous ML estimate. Therefore, in practice, it is noticed that one iteration per bit is sufficient, i.e., the channel estimate from the previous window is a very good initialization for both the simple gradient descent with constant step size and the steepest descent algorithm to estimate the new channel estimate.

### Reduced Size Channel Estimation

In the estimation methods proposed above, the channel could have any number of paths with delays lying within one symbol period. All of these paths will be captured in the channel response vector z. It will be appreciated that no parametric model is assumed on the number of paths. However, in some practical scenarios where the number of paths is small and rectangular chip waveforms are used, the whole z vector may not be needed. For example, when there are just 2 paths for a user and the chip waveform is rectangular, the number of non-zero elements in z corresponding to that user is at most 4.

For other non-rectangular chip waveforms, more coefficients might be non-zero based on the autocorrelation of the pulse waveform used and the delays of the paths.

For the rectangular pulse, the support of the autocorrelation function is only over the interval [−T_{c} T_{c}].

If such information about the pulse shape and paths are available at the receiver, the iterative estimate obtained earlier may be further improved by using this knowledge. This information may be used to reduce the size of the estimated channel response vector \hat{z}.

One simple ad-hoc method to reduce the size of the estimated channel vector \hat{z} is to choose a few large coefficients of \hat{z}. In particular, a few large coefficients, say L, for each user, are chosen which results in a smaller vector of size LK. If the elements that were truly zero were dropped by this procedure, the error in estimation of the zero elements would be made zero and the total squared error in the estimate will be lower. Once the LK significant elements are chosen, the error in these LK elements may be improved by repeating the estimation schemes with a new reduced model of the discrete received signal.

Other complex statistical tests to choose the significant coefficients from the ML estimate may be derived using the ideas in [26], [27]. These techniques would require more computation for possibly marginal performance improvement yielding an interesting complexity-performance trade-off.

Since ML, gradient descent, steepest descent, tracking time-varying channels, and reduced size channel estimation methods are believed to be well known in the art, and for concision purposes, they will not be described herein in more detail.

### Simulation Results

Preliminary simulations were conducted to evaluate the performance of a method for multi-user channel estimation in a multi-access network according to the present invention against the Steepest Decent Maximum Likelihood (SD-ML) and the single user (SU) estimators.

A processing gain of N=16 has been used. The delays of all the users were assumed uniformly distributed in [1 N) chips. The default values of the system parameters, unless otherwise varied along the x-axis are:
the number of observations is M=150;
the signal-to-noise ratio is SNR=8 dB;
the number of users is K=10; and
the number of paths is Pₖ=P=3, k=1, 2, . . . , K.

The relative paths power are 0 dB, −3 dB and −9 dB respectively, the carrier frequency is f_{c}=900 MHz and the chip rate is 1.25MChip/sec. For Loss and MMSE results no payload (data) is considered and K=16, for BER curves the payload (data) is code-multiplexed (analogous to WCDMA system) and K=10 users are considered. In the figures our method is labeled WLMS.

Since a large number of the interdependent parameters are being estimated, it is not very revealing to determine or calculate the estimation error for each individual parameter. It is rather more appealing to look at the loss in dB calculated as follows:

$$Loss = \frac{1}{M} {\sum }_{i = 1}^{M} E [ {( \frac{{z}_{i}}{‖ {z}_{i} ‖} )}^{H} ( \frac{{\hat{z}}_{i}}{‖ {\hat{z}}_{i} ‖} ) ] \qquad ( Equation 40 )$$

which is a measure on the goodness of the path phase estimate required for coherent detection.

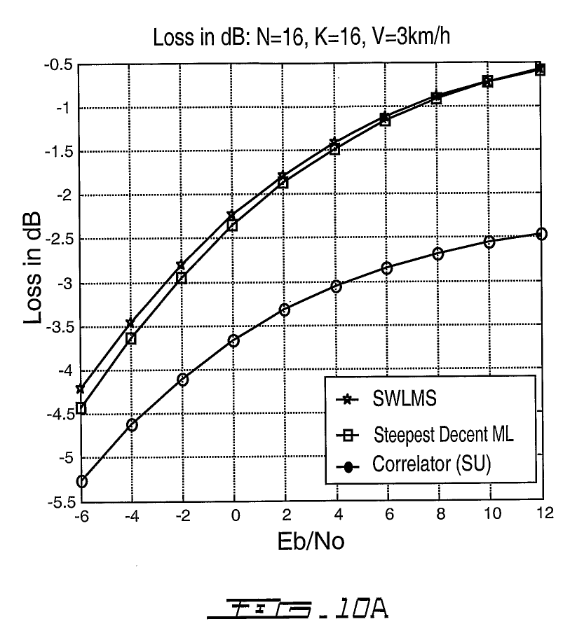

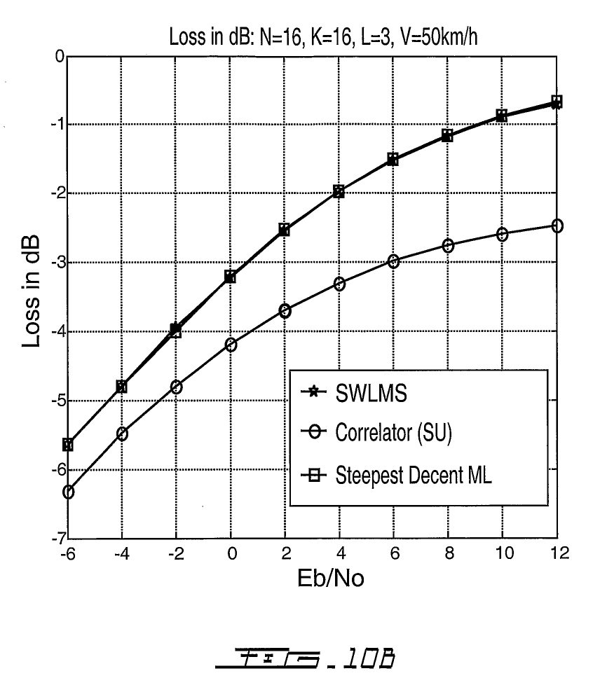

FIGS. 10A and 10B illustrate the loss at different mobile speeds, 3 km/h and 50 km/h. In these results, N=16 and K=16 and no payload is considered.

FIGS. 10A and 10B show the efficiency of the present method compared to Steepest decent ML and the SU methods.

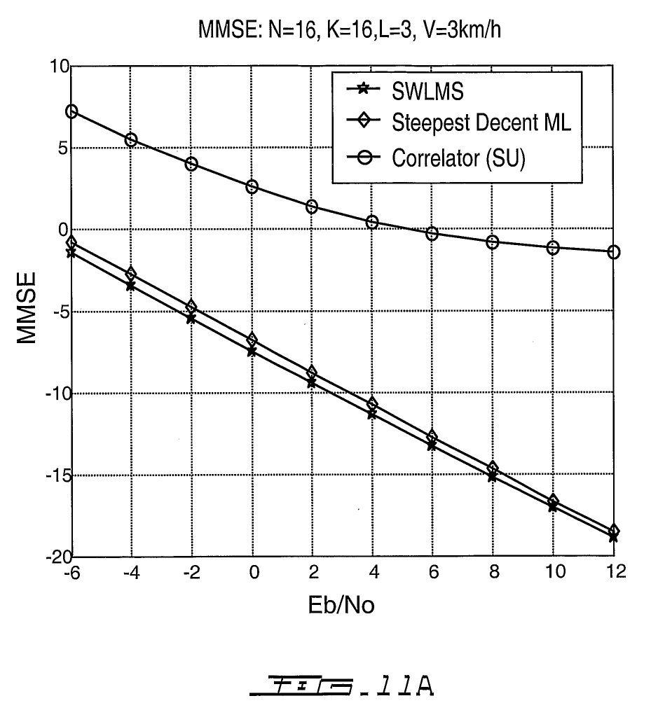

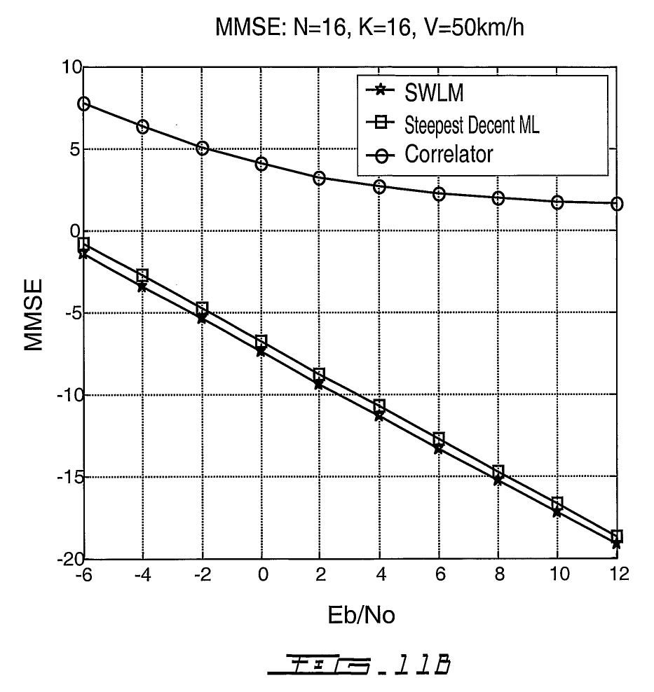

FIGS. 11A-11B illustrate the MMSE in dB. It can be seen from FIGS. 11A-11B that the proposed method outperforms largely the SU and slightly the Steepest Decent ML methods.

A 5-stages multistage receiver followed by a turbo (8 iterations) decoder with constraint length of 4 and generation polynomial (in hexadecimal) (13, 15) was simulated to illustrate how the proposed method affects the Bit Error Rate (BER). The BER was calculated using the estimated channel parameters from the three methods. The number of users is K=10.

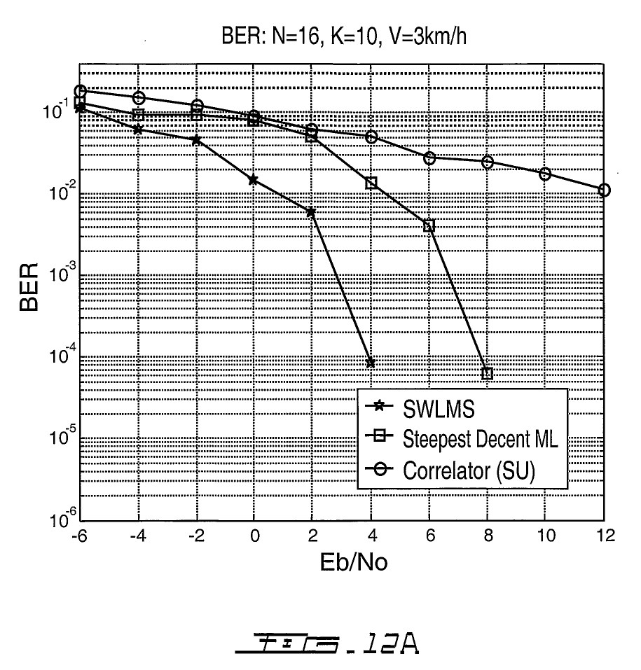

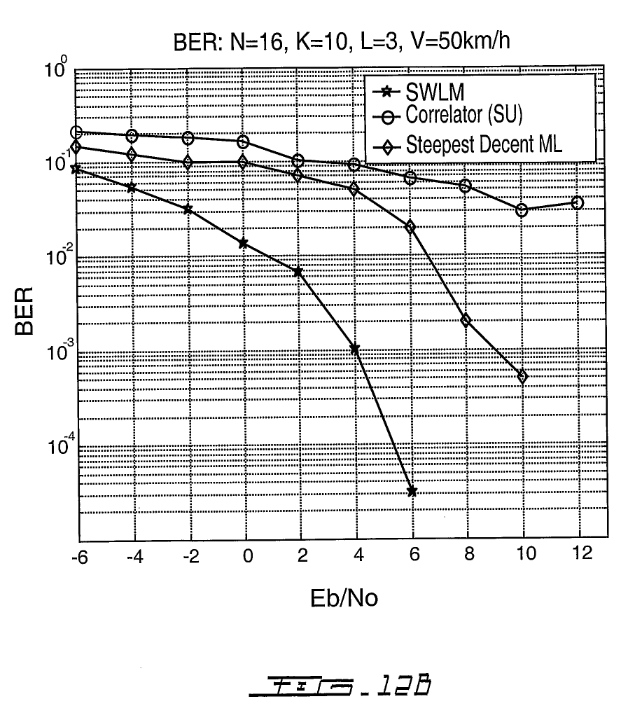

The performance of the present algorithm, shown in FIGS. 12A-12B, is 4 dB superior compared to the Steepest decent ML method, and it is largely superior compared to Single User method.

Even though the present invention as been described with reference to CDMA systems and networks, a method and system according to the present invention can be adapted for other multi-access network.

Although the present invention has been described hereinabove by way of preferred embodiments thereof, it can be modified without departing from the spirit and nature of the subject invention, as defined in the appended claims.

### REFERENCES

All references listed below are herein included by reference.
[1] S. E. Bensley and B. Aazhang. “Subspace-based channel estimation for code division multiple access communication systems,” in IEEE transactions on communications, Vol. 44, No. 8, August 1996, pp. 1009-1020.
[2] S. E. Bensley and B. Aazhang. “Maximum likelihood synchronization of a single user for code division multiple access communication systems,” in IEEE transactions on communications, Vol. 46, No. 3, March 1998, pp. 392-399.
[3] E. G. Strom, S. Parkvall, S. L. Miller, and B. E. Ottersten. “Propagation delay estimation is asynchronous direct-sequence code-division multiple access systems,” in IEEE transactions on communications, Vol. 44, No. 1, January 1996, pp. 84-93.
[4] R. Madyatha and B. Aazhang. “Antenna arrays for joint maximum likelihood parameter estimation in CDMA systems,” in Proceedings CISS, Baltimore, Md., March 1997, Vol. 2, pp. 984-988.
[5] C. Sengupta, J. R. Cavallaro, and B. Aazhang. “Subspace-based tracking of multipath channel parameters for cdma systems,” in European Transactions on Telecommunications, Special issue on CDMA techniques for wireless communication systems, Vol. 9, No. 5, September-October 1998, pp. 439-447.
[6] C. Sengupta, A. Hottinen, J. R. Cavallaro, and B. Aazhang. “Maximum likelihood channel parameter estimation in CDMA systems,” in Proceedings CISS, Princeton, N.J., March 1998.
[7] R. Cameron and B. Woerner. “Synchronization of CDMA systems employing interference cancellation,” in Proceedings VTC, Atlanta, Ga., April 1996, pp. 178-182.
[8] A. Mantravadi and V. V. Veeravalli. “Multi-access interference resistant acquisition for CDMA systems with long spreading sequences,” in Proceedings CISS, Princeton, N.J., March 1998.
[9] J. Thomas and E. Geraniotis. “Iterative MMSE multi-user interference cancellation for trellis coded CDMA systems in multipath fading environments,” in Proceedings CISS, Baltimore, Md., March 1999.
[10] A. J. Weiss and B. Freidlander. “Channel estimation for DS-CDMA downlink with aperiodic spreading codes,” in IEEE transactions on Communications, Vol. 47, No. 10, October 1999, pp. 1561-1569.
[11] Z. Xu and M. K. Tsatsanis. “Blind channel estimation for long code multi-user CDMA systems,” in IEEE Transactions on Signal Processing, Vol. 48, No. 4, April 2000, pp. 988-1001.
[12] M. Torlak, B. L. Evans, and G. Xu. “Blind estimation of FIR channels in CDMA systems with aperiodic spreading sequences” in Conference Record of the Thirty-First asilomar Conference on Signals, Systems, and Computers, November 1997, Vol. 1, pp. 495-499.
[13] S. Bhashyam, B. Aazhang. “Multi-user channel estimation and tracking for long code CDMA systems,” in IEEE Transactions on Communications, Vol. 50, No. 7, July 2002.
[14] C. Sengupta, S. Das, J. R. Cavallaro, and B. Aazhang. “Efficient multi-user receiver for CDMA systems,” in IEEE Wireless communication and networking conference, September 1999, pp. 1459-1463.
[15] E. Ertin, U. Mitra, and S. Siwamgsatham. “Iterative techniques for DS-CDMA multipath channel estimation,” in Allerton Conference, Monticello, Ill., September 1998, pp. 772-781.
[16] P. Y. Kam, C. H. The “An adaptive receiver with memory for slowly fading channels,” in IEEE Transactions on Communications, Vol. COM-32, June 1984, pp. 654-659.
[17] R. Haeb and H. Meyr. “A digital synchronizer for linearly modulated signals transmitted over a frequency selective fading channel,” in IEEE ICC, June 1988, pp. 364-370.
[18] R. Haeb and H. Meyr. “A systematic approach to carrier recovery and detection of digitally phase modulated signals on fading channels,” in IEEE Transactions on Communications, Vol. 37, No. 7, July 1989, pp. 748-754.
[19] W. C. Jakes, Jr. Microwave Mobile Communication. John Wiley & Sons, New York, 1974, p. 75.
[20] L. Lindbom. “Simplified Kalman estimation of fading mobile radio channels: High performance at LMS computational load,” in IEEE ICASSP, Vol. 3, April 1993, pp. 352-355.
[21] P. Dent and G. E. Bottomley, T. Croft. “Jales fading model revisited,” in IEEE Electronics Letters, Vol. 29, No. 13, June 1993, pp. 1162-1163.
[22] P. H. Yu Wu and A. Duel-Hallen. “Multi-user detection and channel estimation for fast Rayleigh fading mobil radio CDMA channels” in Technical Report, April 1998.
[23] S. Haykin. Adaptive Filter Theory. Information and System Sciences Series. Prentice Hall, 3rd edition, 1996.
[24] M. Honing, U. Madhow, and S. Verdu. “Blind adaptive multi-user detection,” in IEEE Transactions on information Theory, Vol. 41, No. 4, July 1995, pp. 944-960.
[25] G. H. Golub and C. F. Van Loan. Matrix computations. The Johns Hopkins University Press, 3rd edition, 1996
[26] A. Wald. “Tests of statistical hypotheses concerning several parameters when the number of observations is large” in Transactions of American Mathematical Society, Vol. 54, No. 3, November 1943, pp. 426-482.
[27] C. R. Rao. Linear Statistical Inference and its Applications. Wiley Publications, 1966.
[28] Kareem E. Baddour, Norman C. Beaulieu. “Autoregressive models for fading channel simulation,” in IEEE Global Telecommunications Conference, No. 1, November 2001, pp. 1187-1192.
[29] L. Lars, M. Sternad and A. Ahlèn. “Tracking of time-varying mobile radio channels, Part I: The Wiener LMS Algorithm” in IEEE Trans. on commun., Vol. 49, No. 12, December 2001.

What is claimed is:

1. A method for multi-user channel estimation in a multi-access network comprising:
a) providing a communication signal (rᵢ) corresponding to instant i;
b) providing an estimated communication signal (\hat{r}ᵢ);
c) comparing said communication signal (rᵢ) to said estimated communication signal (\hat{r}ᵢ) to provide an error signal (εᵢ); and
d) generating an estimated composite channel impulse response signal (\hat{z}ᵢ) using said error signal.

2. A method as recited in claim 1, wherein said estimated communication signal (\hat{r}ᵢ) is generated using a spreading code signal (Cᵢ), an information sequence signal (Bᵢ) and a predicted composite channel impulse response signal (\hat{z}_{i|i-1}).

3. A method as recited in claim 2, wherein \hat{r}ᵢ=CᵢBᵢ\hat{z}_{i|i-1}.

4. A method as recited in claim 2, wherein said predicted composite channel impulse response signal (\hat{z}_{i|i-1}) includes a smoothing finite impulse response (FIR) component and a prediction FIR component.

5. A method as recited in claim 1, wherein comparing said communication signal (rᵢ) to said estimated communication signal (\hat{r}ᵢ) to provide an error signal (εᵢ) includes computing said error signal as εᵢ=rᵢ−rᵢ.

6. A method as recited in claim 2, wherein generating an estimated composite channel impulse response signal (\hat{z}ᵢ) using said error signal (εᵢ) further making use of said spreading code signal (Cᵢ) and said information sequence signal (Bᵢ).

7. A method as recited in claim 6, wherein \hat{z}ᵢ=\hat{z}_{i|i-1}+μCᵢBᵢεᵢ where μ is an adaptation parameter.

8. A method as recited in claim 1, wherein steps a) to d) is iterated from i=1, 2, . . . , M.

9. A method as recited in claim 2, wherein said estimated communication signal (\hat{r}ᵢ) is generated using a spreading code signal (Cᵢ), an information sequence signal (Bᵢ) and a predicted composite channel impulse response signal (\hat{z}_{i|i-1}) at instant i taking into account all data until instant i−1; wherein \hat{z}_{0|0-1}=0.

10. A method as recited in claim 9, wherein
\hat{z}ᵢ=\hat{z}_{i|i-1}+μXᵢεᵢ
Wherein Xᵢ=CᵢBᵢ; and where μᵢ is an adaptation parameter.

11. A method as recited in claim 10, wherein
$$\begin{matrix}{μ}_{i} = \frac{{ɛ}_{i}^{H} {ɛ}_{i}}{{ɛ}_{i}^{H} {X}_{i}^{H} {X}_{i} {ɛ}_{i}} or {μ}_{i} \\ = \frac{{ɛ}_{i}^{H} {ɛ}_{i}}{2 N φ} or {μ}_{i} \\ = 1 - \frac{{δ}_{u}}{\vert {ɛ}_{i} \vert} , {δ}_{u} ∈ [ 0 ∞ ) or {μ}_{i} \\ = \frac{{‖ {X}_{i} {ɛ}_{i} ‖}^{2}}{{‖ {X}_{i}^{H} {X}_{i} {ɛ}_{i} ‖}^{2}} .\end{matrix}$$

12. A method as recited in claim 10, wherein μᵢ is determined using a Multi-user Steepest Wiener LMS (Multi-user S-WLMS) method.

13. A method as recited in claim 9, wherein \hat{r}ᵢ=CᵢBᵢ\hat{z}_{i|i-1}.

14. A method as recited in claim 9, wherein said predicted composite channel impulse response signal is provided by
\hat{z}_{i+1|i}=\hat{z}ᵢ^{prediction}+\hat{z}ᵢ^{smoothing}.

15. A method as recited in claim 14, wherein
$${\hat{z}}_{i}^{smoothing} = - {\sum }_{n = 1}^{{N}_{smoothing}} {ξ}_{n} {\hat{z}}_{i - n - 1} ;$$
where ξₙ are predetermined coefficients.

16. A method as recited in claim 14, wherein
$${\hat{z}}_{i}^{prediction} = - {\sum }_{n = 1}^{{N}_{prediction}} {ζ}_{n} {\hat{z}}_{i - n + 1 \vert i - n}$$
where ζₙ are predetermined coefficients.

17. A method as recited in claim 14, wherein
\hat{z}ᵢ^{smoothing}=−ξ₁\hat{z}ᵢ−ξ₂\hat{z}ᵢ₋₁ and
\hat{z}ᵢ^{prediction}=−ζ₁\hat{z}_{i|i-1}
wherein
$${ζ}_{1} = ( 1 - μ ) {ξ}_{1} {ξ}_{2} , {ξ}_{1} = \frac{{a}_{1}}{1 + {a}_{2} ( 1 - μ )} and {ξ}_{2} = {a}_{2} ,$$
a₁=−2r_{d} cos(2πf_{d}′T) a₂=r_{d}², and where f_{d}′ is a spectral peak frequency, μ is a parameter ranging between about [0.001 and 0.5], T is a period of a symbol, and r_{d} is a pole radius corresponding to a steepness of peaks of the power spectrum of the fadings.

18. A method as recited in claim 1, wherein a least mean squares (LMS) algorithm is used in said generating an estimated composite channel impulse response signal (\hat{z}ᵢ) using said error signal (εᵢ).

19. A method as recited in claim 1, wherein said communication signal (rᵢ) is received at a base station or at a mobile station.

20. A method as recited in claim 1, wherein said communication signal (rᵢ) is a superposition of attenuated and delayed signals transmitted by a plurality of users.

21. A method as recited in claim 20, further comprising e) extracting delays and path attenuation values for each of said plurality of users from said estimated composite channel impulse response signal (\hat{z}ᵢ).

22. A method as recited in claim 21, wherein steps a) to e) is iterated from i=1, 2, . . . , M.

23. A method as recited in claim 22, wherein said estimated composite channel impulse response signal (\hat{z}ᵢ) is used to compute a variance vector, which is expressed as:
$${v}_{i} = \frac{i - 1}{i} {v}_{i - 1} + \frac{1}{i} {w}_{i}$$
with wᵢ=[|\hat{z}_{i,1}|²,|\hat{z}_{i,2}|², . . . , |\hat{z}_{i,K(N+1)}|²]^{T}
with v₀=0 and z_{i,j} representing the jth elements of the vector z at instant i; wherein said variance vector is searched over by segments for delay detection for each of said plurality of users k=1, 2, . . . , K.

24. A method as recited in claim 23, wherein said variance vector is searched beginning at position (k−1)(N+1)+1 and terminating at position k(N+1) to select the largest components (p=1, 2, . . . , Pₖ) to be considered as a path position for which at least one of a path attenuation {ŵ_{k,p}} or delay signal {\hat{τ}_{k,p}} is deduced from \hat{z}ᵢ at a same element position.

25. A method as recited in claim 20, wherein the multi-access network is a direct sequence code division multiple access (DS-CSMA) network.

26. A method as recited in claim 24, wherein said DS-CDMA network is selected from the group consisting of WCDMA, cdma2000 and TD-SCDMA.

27. A channel estimation module for a multi-user access network system, comprising:
a processor for receiving a transmitted communication channel signal and for provided a plurality of estimated composite channel impulse response signals in accordance with control parameters being modified by an error feedback signal; and
a feedback unit coupled to said processor for receiving said estimated composite channel impulse response signal and a plurality of estimated composite receiver's antennas channel impulse signals for each communication channel signal of the transmitted communication signal and for determining and providing to said processor said error feedback signal in response to both said estimated composite channel impulse response signal and a plurality of estimated composite receiver's antennas channel impulse signals.

28. A channel estimation module as recited in claim 27, wherein said error feedback signal including a plurality of components; each of said components being related said plurality of estimated composite receiver's antennas channel impulse signals.

29. A channel estimation module as recited in claim 27, wherein the multi-access network is a direct sequence code division multiple access (DS-CSMA) network.

30. A channel estimation module as recited in claim 29, wherein said DS-CDMA network is selected from the group consisting of WCDMA, cdma2000 or TD-SCDMA.

31. An equalizer/detection unit for a multi-user access network system comprising:
a channel estimation module as recited in claim 27; and
a data detection unit coupled to said channel estimation module to receive said plurality of estimated composite channel impulse response signals form said channel estimation module to use said plurality of estimated composite channel impulse response signals to provide estimated transmitted binary data.

32. A multi-antenna system for a multi-access network comprising:
a plurality of receiving antennas, each having an antenna output;
a plurality of channel estimation modules as recited in claim 27, each coupled to a respective of said plurality of receiving antennas so as to receive said transmitted communication channel signal from said antenna output; and
a finger management unit coupled to said plurality of channel estimation modules for receiving said plurality of estimated composite channel impulse response signals therefrom and for using said plurality of estimated composite channel impulse response signals to provide at least one of path attenuation and delay signal corresponding to each of said plurality of receiving antennas.

33. A multi-stage method for channel estimation in a multi-access network comprising:
i) using the method as recited in claim 24 to provide path attenuation {ŵ_{k,p}} or delay signal {\hat{τ}_{k,p}} for at least some of said users K;
ii) repeating step i) at least one time using selected components of resulted estimated composite channel impulse response signal (\hat{z}ᵢ) from step i).
